(19) United States
(12) Patent Application Publication
(10) Pub. No.: US 2010/0212525 A1
(43) Pub. Date: Aug. 26, 2010

(54) METHOD FOR OPERATING A PRINTING PRESS

(75) Inventors: Joachim Blumor, Hainburg (DE); Klaus-Peter Reichardt, Bad Vilbel (DE); Harald Togel, Schlangenbad 3 (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Manroland AG, Offenbach (DE)

(21) Appl. No.: 12/738,188

(22) PCT Filed: Sep. 26, 2008
(86) PCT No.: PCT/EP2008/008181

§ 371 Date: May 11, 2010

(30) Foreign Application Priority Data
Oct. 16, 2007 (DE) 10 2007 049 455.8

(51) Int. Cl. B41L 39/00

(52) U.S. Cl. 101/484

(57) ABSTRACT

The invention relates to a method for operating a printing press, particularly a sheet-fed offset printing press, wherein at least two drives, whose positions can be controlled independently from each other, feed into a continuous gear train of the printing press. A desired torque distribution for the drives feeding into the continuous gear train is determined such that each drive provides a driving torque for the associated sub-unit of driven devices and in part for the sub-unit of driven devices associated with a drive connected downstream of the respective drive, wherein based on said torque distribution for each drive an individual angle target value is determined, which is used to control the position of each drive individually in order to provide an angular difference that is dependent on the torque distribution between the feed sites of the drives.

### CROSS-REFERENCE TO RELATED APPLICATIONS

This patent application is the national phase of PCT/EP2008/008181, filed Sep. 26, 2008, which claims the benefit of German Patent Application No. 102007049455.8, filed Oct. 16, 2007.

### FIELD OF THE INVENTION

The present invention relates generally to a method for controlling operation of a printing press, and particularly, to a sheet-fed offset printing press.

### BACKGROUND OF THE INVENTION

From DE 101 15 546 A1 a method is known for operating a printing press, in particular a sheet-fed offset printing press, in which two drives, whose positions can be controlled independently from each other, feed into a continuous gear train of the printing press. In this regard, the devices of the printing press to be driven and coupled to the gear train are driven specifically in a manner such that rotation of the gear train is effected between the feed sites of the drives acting on the continuous gear train.

According to DE 101 15 546 A1, a rotational angle position of the continuous gear train is measured at two different positions thereof, and the position of the drive acting on the continuous gear train is adjusted as a function of a rotational angle difference obtained from the measured rotational angle positions. According to this prior art, a rotational angle difference control is established which is based on a rotational angle difference determined by measurement in the gear train.

### OBJECTS AND SUMMARY OF THE INVENTION

It is an object of the present invention to provide a method for more efficiently controlling the operation of a printing press, and particularly a sheet fed printing press, for improved print quality.

According to the invention, a desired torque distribution for the drives feeding into the continuous gear train is determined such that each drive provides a driving torque for a sub-unit associated with the same and furthermore for a sub-unit associated with a drive connected downstream of the respective drive, wherein based on said torque distribution for each drive an individual angle target value is determined, which is used to control the position of each drive individually in order to provide an angular difference that is dependent on the torque distribution between the feed sites of the drives.

With respect to the inventive method, sensors to measure a rotational angle difference are now no longer needed. Therefore, costs can be reduced. Furthermore, a position control of drives feeding to the continuous gear train is possible on the basis of a preferred torque distribution of the continuous gear train so that the print quality can be improved.

Preferably, in order to determine the desired torque distribution between the drives driven in the continuous gear train, a torque requirement for each drive is calculated or is determined experimentally such that the drive on the one hand covers the torque requirement of the sub-unit allocated thereto, and on the other hand covers a portion of the torque requirement of the same downstream sub-unit to which a separate drive is allocated.

To determine the individual angle target value for each drive, an angle difference between the feed sites of the drives is changed experimentally until the previously determined, desired torque distribution is obtained, wherein the determined angle values of the drives are saved as angle target values.

According to a further favorable embodiment of the invention, given an individual position control of the drives, the torque distribution actually occurring during the position control is determined, and wherein in this regard a check is made to ascertain whether the actually occurring torque distribution is within a tolerance band defined by an upper limit value and a lower limit value around the desired torque distribution, wherein then, if it is thereby determined that the actual torque distribution is within the tolerance band, the angle target values for position control of the drives remain unchanged, and then if it is thereby determined that the actual torque distribution is outside of the tolerance band, at least one angle target value is adjusted automatically for position control of one drive such that the actual torque distribution is again located within the tolerance band.

Other objects and advantages of the invention will become apparent upon reading the following detailed description and upon reference to the drawings, in which:

### BRIEF DESCRIPTION OF THE DRAWINGS

FIG. 1 is a schematic of a sheet-fed offset printing press controlled by the method according to this invention.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENTS

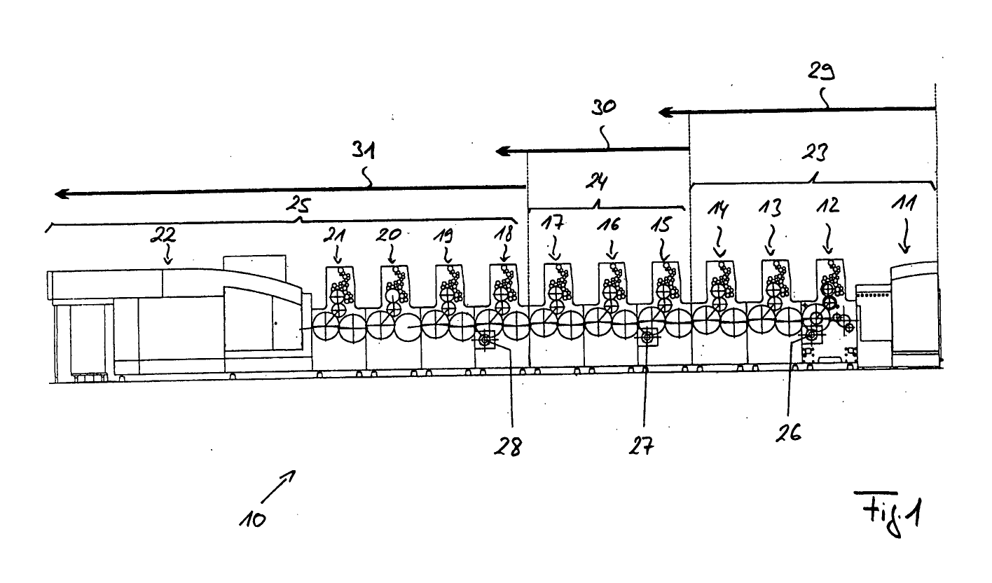

The present invention relates to a method for operating a printing press, particularly a sheet-fed offset printing press, wherein at least two drives, whose positions can be controlled independently from each other, feed into a continuous gear train of the printing press. The method according to the invention is explained in detail below with reference to the sheet-fed offset printing press 10 illustrated in FIG. 1, which in this case comprises a feeder 11, ten printing presses 12, 13, 14, 15, 16, 17, 18, 19, 20 and 21, and a delivery unit 22.

The feeder 11 together with the first three printing presses 12, 13 and 14 form a first sub-unit 23 of the sheet-fed offset printing press. The printing presses 15, 16 and 17 form a second sub-unit 24 of the sheet-fed offset printing press 10. The printing presses 18, 19, 20 and 21 together with the delivery unit 22 form a third sub-unit 25 of the sheet-fed offset printing press 10. The feeder 11, the printing presses 12-21 and the delivery unit 22 each are driven devices of the sheet-fed offset printing press 10.

The sheet-fed offset printing press 10 in FIG. 1 has a continuous gear train wherein in the embodiment illustrated in FIG. 1, three drives 26, 27 and 28 are operatively coupled to and feed into the continuous gear train at mutually spaced feed sites. One drive is allocated to each sub-unit 23, 24 and 25 of the sheet-fed offset printing press 10, wherein according to FIG. 1, drive 26 is allocated to the first sub-unit 23, drive 27 to the second sub-unit 24, drive 28 to the third sub-unit 25. The drive 26 is used primarily to drive the feeder 11 and also the printing presses 12-14 of the printing unit 23. The drive 27 is used primarily to drive the printing presses 15-17 of the sub-unit 24. Drive 28 is used primarily to drive the printing presses 18-21 and also the delivery unit 22 of sub-unit 25 of the sheet-fed offset printing press 10.

Accordingly, in the embodiment in FIG. 1 the sheet-fed offset printing press 10 is subdivided into the three sub-units 23, 24 and 25 which each have several devices to be coupled to the continuous gear train, wherein each sub-unit 23, 24 and 25 comprises one of the drives 26, 27 and 28. Accordingly, each sub-unit 23, 24 and 25 is allocated to one of the drives 26, 27 and 28. It will be appreciated that the number of sub-units into which the sheet-fed offset printing press is sub-divided, and accordingly also the number of the drives feeding into the continuous gear train may differ from the embodiment illustrated in FIG. 1. Hence, merely two sub-units and thus two drives may be present, or there may be more than three sub-units and respective drives.

The sub-units 23, 24 and 25 of the sheet-fed offset printing press 10 in FIG. 1 are driven by the drives 26, 27 and 28 so that feed sites of the drives 26, 27 and 28, such as the drive shafts of the individual drives, are rotated with respect to each other in order to create an angular difference between the feed sites, and thus sub-units 23, 24 and 25, which as well understood by a person skilled in the art can be measured by a respective sensor on the drive shaft. Thus, the need for an alternation between gear tooth flanks of the sub-units 23, 24 and 25 of the sheet-fed offset printing press 10, which has an adverse impact upon the print quality, can be avoided.

In carrying out the invention, for the drives feeding into the continuous gear train of the printing press, a desired torque distribution is defined in that each drive 26, 27 and 28 produces a drive torque, first for the sub-unit 23, 24 and 25, allocated thereto, and additionally for the drive downstream of the particular drive 26, 27 and 28. In the illustrated embodiment, this means that the drive 26 produces a drive torque for the sub-unit 23 and a drive torque for the sub-unit 24. The drive 27 produces a drive torque for sub-unit 24 and sub-unit 25. The drive 28 produces a drive torque for sub-unit 25. Based on the particular desired torque distribution for the drives 26, 27 and 28, an angle target value is determined individually for each drive; and based on this value, each drive 26, 27 and 28 can be individually position-controlled in order to provide an angular difference between the feed sites of the drive depending on the desired torque distribution.

To determine the desired torque distribution between the drives 26, 27 and 28 feeding into the continuous gear train, a torque requirement is determined experimentally or by calculation for each drive, namely such that the drive first covers the torque requirement of the sub-unit allocated thereto, and secondly covers a portion of the torque requirement of the sub-unit downstream thereof, which is allocated to the particular drive.

Arrows 29, 30 and 31 in FIG. 1 represent each torque requirement of the drives 26, 27 and 28, wherein the torque requirement 29 of the drive 26 of sub-unit 23 covers the torque requirement of the feeder 11 and also of printing presses 12, 13 and 14, and in addition, produces a portion of the torque requirement for sub-unit 24. The torque requirement 30 of drive 27 of sub-unit 24 covers the torque requirement of printing presses 15, 16 and 17, and moreover produces a portion of the torque requirement of sub-unit 25. The torque requirement 31 of drive 28 of sub-unit 25 is used to cover the torque requirement of printing presses 18-21 and of the delivery unit 22.

Based on the torque distribution determined experimentally or by calculation as indicated above, an angular difference between the feed sites of drives 26, 27 and 28, i.e., the drive shafts, is varied experimentally to determine the individual angle target value for the particular drives 26, 27 and 28, until the previously defined, desired torque distribution is adjusted. Thus angular values of the drives 26, 27 and 28 determined in this manner are saved as angle target values or as difference angles relative to a lead angle applicable to all sub-units. In the above determination of the individual angle target values for drives 26, 27 and 28 it is possible to vary the desired torque distribution and thus to save a characteristic line dependent on the angular difference and torque distribution for determining the individual angle target values.

The angle target values for the individual drives 26, 27 and 28 determined in the above manner are valid preferably for an operating mode of the sheet-fed offset printing press 10, for example, for continuous printing. In order to produce angle target values dependent on operating mode for other types of operation of sheet-fed offset printing presses, the angle target value of each drive can be corrected by an offset value depending on the operating mode, wherein separate offset values are kept ready for an acceleration and/or a deceleration and/or a change in direction of rotation and/or a set-up mode and/or for an adjustment of format length in first and second print mode of the sheet-fed offset printing press.

Accordingly, by means of the present invention it is possible to establish a position control for the drives feeding into a continuous gear train of a printing press in such a manner that a desired torque distribution of the drives is defined such that, based on the desired torque distribution, individual angle target values are determined for the drives and that based on these individual angle target values, each drive will be individually position-controlled, namely in a manner such that an angular difference depending on the torque distribution will form between the feed sites of the drives.

According to another desirable embodiment of the present invention, the torque distribution of the drives actually occurring is determined for the individual position control of the drives 26, 27 and 28, and specifically on the basis of the driving current of the drives 26, 27 and 28. In this case a check is made to determine whether the actually occurring torque distribution is within a tolerance band around the desired torque distribution, wherein the tolerance band around the desired torque distribution is defined by an upper limit value and by a lower limit value.

If it is thus determined that the actual torque distribution is within the tolerance band, then the angle target values for individual position control of the drives remain unchanged.

However, if it is then found that the actual torque distribution is outside of the tolerance band around the desired torque distribution, then at least one angle target value is changed automatically for position control of one drive, in such a manner that the actual torque distribution is again within the tolerance band around the desired torque distribution. This adjustment of the angle target value occurs in relatively small steps over a relatively long period of time.

The above continuous adaptation of angle target values takes place especially when a format length adjustment of the gear train of the sheet-fed offset printing press 10 takes place for the first- and second-print. In a format length adjustment in first- and second print operation, the gear train has to be opened in order to rotate the devices of the sheet-fed offset printing press used for driving in first-print mode, and in second print mode for the purpose of format adjustment, wherein after a subsequent closing of the gear train, the original torque distribution is not automatically present, but rather has to be established again, in steps, by means of a corresponding adaptation of the angle target values for the position control.

To produce a pre-control component for implementing of a change in direction of rotation, for each drive, individual angle target values can be adjusted, depending on the play between teeth of the gears which is present between the feed sites of the drives. In this manner, operation is possible with a suitable torque distribution during a reversal of the direction of rotation.

The advantage of the inventive method, which is based on a position control of the drives feeding into the continuous gear train, with respect to the method based on a torque control, is that potential fluctuations in torque do not cause changes in required angle allocations between the individual feed sites and thus the print quality is not adversely impacted. Due to the required angle allocation to the feed sites of the drives, any torque fluctuations within the sub-units of the printing machine will also cause angle errors, but in total they are much smaller than for a mechanical, longitudinal shaft, since each sub-unit regulates its own angle errors independently and/or individually.

### LIST OF REFERENCE SYMBOLS

10 Offset printing press
11 Feeder
12 Printing press
13 Printing press
14 Printing press
15 Printing press
16 Printing press
17 Printing press
18 Printing press
19 Printing press
20 Printing press
21 Printing press
22 Delivery unit
23 Sub-unit
24 Sub-unit
25 Sub-unit
26 Drive
27 Drive
28 Drive
29 Torque requirement for drive 26
30 Torque requirement for drive 27
31 Torque requirement for drive 28

1-8. (canceled)

9. A method of controlling operation of a printing press, such as a sheet fed offset printing press, having two drives whose angular rotational position can be controlled independently from each other and which feed into and drive a continuous gear train of the printing press at successive locations in a downstream direction, the printing press having a plurality of devices coupled to and driven by the gear train, said drives each being used for driving a respective associated sub-unit of the printing press comprising at least one driven device, and said drives having feed sites to the gear train that are rotated relative to each other for providing an angular difference, comprising the steps of:
determining a desired torque distribution for the drives feeding the continuous gear train such that each drive provides a driving torque for the sub-unit associated with the respective drive and furthermore in for a sub-unit associated with a drive connected downstream of the respective drive,
determining from said torque distribution for each drive an individual angle target value, and
controlling an angular position of each drive individually based upon the individual angle target value for providing an angular difference that is dependent upon the torque distribution between the feed sites of the drives.

10. The method of claim 9 including determining the desired torque distribution between the drives for the continuous gear train by calculating the torque requirement for each drive such that the drive covers the torque requirement of the sub unit associated with the drive and a portion of the torque requirement of a downstream sub unit associated with a separate drive.

11. The method of claim 9 including determining the desired torque distribution between the drives for the continuous gear train by experimentally determining the torque requirement for each drive such that the drive covers the torque requirement of the sub unit associated with the drive and a portion of the torque requirement of a downstream sub unit associated with a separate drive.

12. The method of claim 11 including determining the individual angle target value of each drive by experimentally changing the angle difference of the feed site of the drive until the previously determined desired torque distribution is obtained, and then saving the determined angle target value of the drive as the angle target value.

13. The method of claim 12 including determining and saving a characteristic line dependent on the angle difference and torque distribution as the desired torque distribution for the respective drive is varied.

14. The method of claim 9 including correcting the angle target value of each drive according to the type of operation of the printing press.

15. The method of claim 9 including determining the actual torque distribution occurring during an individual position control of the drives, comparing whether the actually occurring torque distribution is within a tolerance band defined between upper and lower limits about the desired torque distribution, and if it is determined that the actual torque distribution is within the tolerance band leaving the angle target values unchanged for the position control of the drives, and if it is determined that the actual torque distribution is outside the tolerance band, automatically adjusting at least one angle target value position control of one drive such that the actual torque distribution is again within the tolerance band.

16. The method of claim 15 including carrying out the comparison and automatic adjustment steps after a format length adjustment is made in the printing press between first and second different printing operations.

17. The method of claim 9 including determining the individual angle target value of each drive for a reversal of the direction of rotation of the gear train taking into account the play between teeth of the gears present between the feed sites of the drives and the gear train.
